(19) United States
(12) Patent Application Publication
(10) Pub. No.: US 2017/0196216 A1
(43) Pub. Date: Jul. 13, 2017

(54) Retractable Blind Assembly

(71) Applicant: Marc D. Pichik, Dubuque, IA (US)

(72) Inventor: Marc D. Pichik, Dubuque, IA (US)

(73) Assignee: Smart Retract Inc., Dubuque, IA (US)

(21) Appl. No.: 14/991,924

(22) Filed: Jan. 9, 2016

(51) Int. Cl. A01M 31/00

(52) U.S. Cl. CPC A01M 31/00

(57) ABSTRACT

A blind assembly for camouflaging a hunter and setup configurations for the blind assembly are disclosed. The blind assembly contains two sheets wound together into a roll that are configured for separate outstretching at an angle relative to each other, for being maintained under tension in an outstretched form, and for retraction back into the roll. The end of each sheet contains a handle rod used for handling the sheets and for anchoring to the ground by means of attaching to stakes inserted into the ground using ropes. The roll end of the assembly structure is likewise attached to a stake in the course of setting up the blind assembly in a hunting field.

### FIELD OF THE INVENTION

The present invention relates to embodiments of a blind assembly for outdoor uses and embodiments for setting up and utilizing the blind assembly.

### BACKGROUND OF THE INVENTION

Hunters often use camouflages in hunting fields to conceal their presence from animals that may run away if they are detected. It would, therefore, be desirable to construct a camouflage or blind in a way that allows quick assembly, quick setup and quick disassembly.

### SUMMARY OF THE PRESENT INVENTION

It is an object of the present invention to provide a hunting blind for camouflaging a hunter that a hunter could set up and quickly in the field, take down and carry with via a shoulder strap.

In one aspect of the present invention, a retractable blind assembly comprises a reel tube having a top end and a bottom end; a first sheet and a second sheet, the first sheet joining the second sheet to form a combined sheet having a rear end and a front end, the combined sheet being wound over the reel tube to form a sheet roll with the rear end of the combined sheet being disposed inside the roll to form a retracted configuration, the first sheet and second sheet being configured for unwinding from the sheet roll separately to form an outstretched blind at an angle, the first sheet having a front end and the second sheet having a front end; a base housing adapted for placement onto a ground surface, the base housing containing a rear vertical extension and a front vertical extension, the bottom of the reel tube being adapted to fit onto the front vertical extension of the base frame; a tie rod having a top side and a bottom side, the bottom side being adapted for placement into the rear vertical extension of the base housing; a torsion spring adapted to tightly fit inside the reel tube, the torsion spring being adapted for applying tension onto the outstretched blind; and a housing assembly attached to the top of the sheet roll and the top of the tie rod.

These and other features, aspects and advantages of the present invention will become better understood with reference to the following drawings, description and claims.

### BRIEF DESCRIPTION OF THE DRAWINGS

FIG. 1 portrays a perspective view of the assembly for outstretching and retracting a blind according to an embodiment of the present invention;

FIG. 2 presents an exploded view of the assembly for outstretching and retracting a blind according to an embodiment of the present invention;

FIG. 3 is a perspective view of the assembly for outstretching and retracting a blind in a use configuration according to an embodiment of the present invention;

FIG. 4 shows a top cutaway view of the assembly for outstretching and retracting a blind according to an embodiment of the present invention;

FIG. 5 is a top cutaway view of the assembly for outstretching and retracting a blind in a use configuration according to an embodiment of the present invention; and

FIG. 6 is a top cutaway view of the assembly for outstretching and retracting a blind in another use configuration according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The assembly of the present invention contains two sheets wound into one roll. The sheets are configured for unwinding from the roll, for extending from the roll to form two blinds, and for retracting back into a roll form.

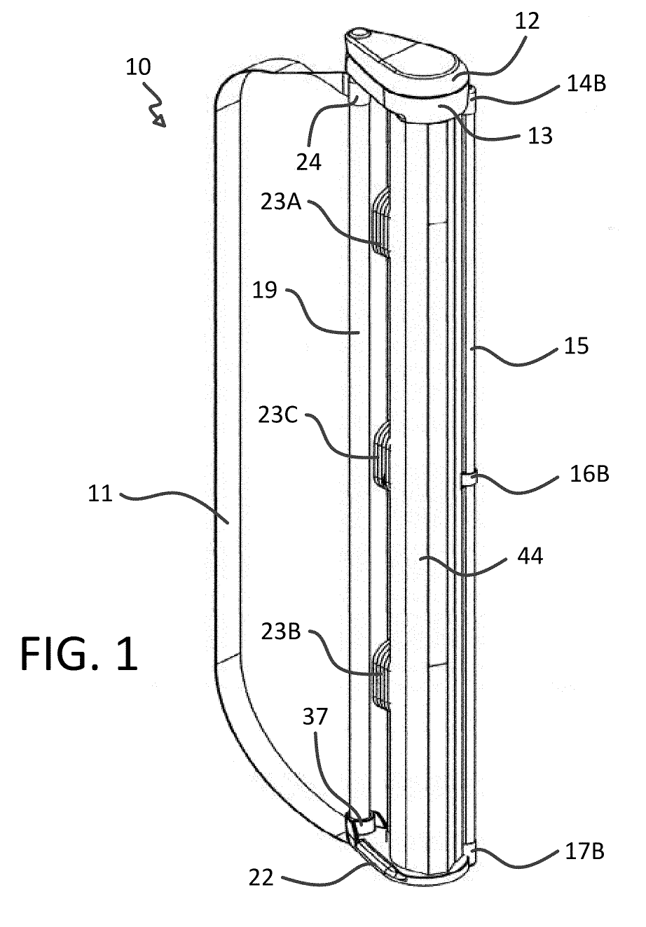

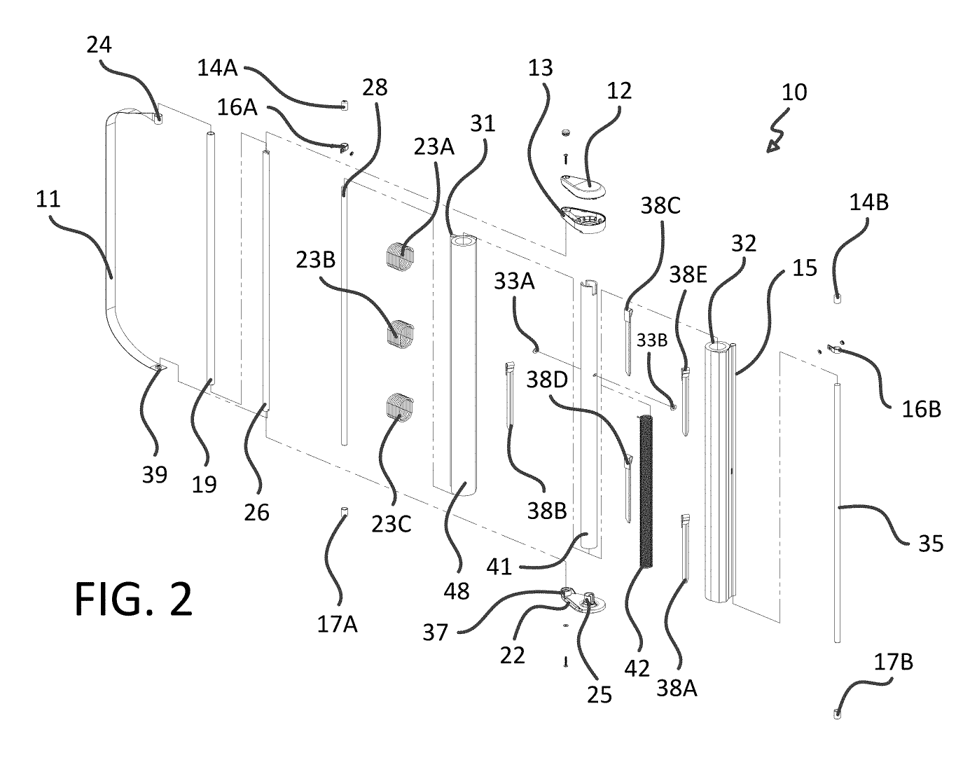

FIGS. 1-6 show the retractable blind assembly 10 and configurations of the assembly set up for use 20. The retractable blind assembly 10 comprises two sheets 43 and 44 wound into a roll 49. The sheet material of construction is preferably a flexible yet strong fabric. The mesh of the fabric may be open or closed. However, other materials of construction, such as metal or plastic, also fall within the scope of the present invention. In the construction of the assembly, two rolls 32 and 48 are wound into one roll 49. To construct roll 49, the back sides of sheets 43 and 44 are attached at their back edges and together are wound around reel tube 41. The front edge of each sheet 43 and 44 is attached respectively to rigid handle rods 28 and 35. The handle rods 28 and 35 may be attached to the front edges of sheets 43 and 44 through loop pockets 31 and 15 sewn into the sheet front edges; however, other attachment means also fall within the scope of the present invention.

Torsion spring roll 42 is inserted inside reel tube 41. The torsion spring roll applies tension onto combined sheets 43 and 44 when the user pulls out the sheets using the handle rods 28 and 35 to set up the blind assembly 10 in a hunting field.

The assembled retractable blind 10 shown in Figures is set vertically onto base housing 22 which is placed onto the ground in the field. The base housing 22 contains a hollow rear vertical extension 37 and a front vertical extension 25.

The assembly 10 is subjected to forces exerted by the pulling out and retracting of the sheets. It is therefore important to construct the assembly 10 such that it is stable, that it would not come apart in use or collapse. A number of provisions are made to reinforce the structure. A tie rod 26 is inserted into rear vertical extension 37 of base housing 22 while the reel tube 41 is placed over front vertical extension 25 of base housing 22. Protective sleeve 19 slips over tie rod 26 to provide additional rigidity. A housing assembly comprised of middle housing 13 and upper housing 12 is attached to the top side of the tie rod 26 and to the reel tube 41 to keep the top of the assembly together.

Additional components used for reinforcing the assembly structure and/or help it function include: upper caps 14A and 14B and lower caps 17A and 17B placed onto handle rods 28 and 35 respectively, and clamps 16A and 16B that fasten onto the middle portions of the respective handle rods 28 and 35.

The caps 14A and 14B are placed over the top of their respective handle rods 28 and 35 and lower caps 17A and 17B are placed over the bottom of the handle rods 28 and 35. Caps 14A and 14B function as stops resting against middle housing 13 to prevent the fully rewound sheet from rewinding too far. Clamps 16A and 16B fasten around the loop pockets 31 and 15 and their respective handle rods 28 and 35 to prevent the handle rods 28 and 35 from sliding out of the loop pockets 31 and 15.

Strap 11 is attached to top of the tie rod sleeve 19 and tie rod 26 through sewn loop 24 and clip 39 fastened onto the bottom of base housing 22. The strap 11 is used for carrying around the blind assembly 10.

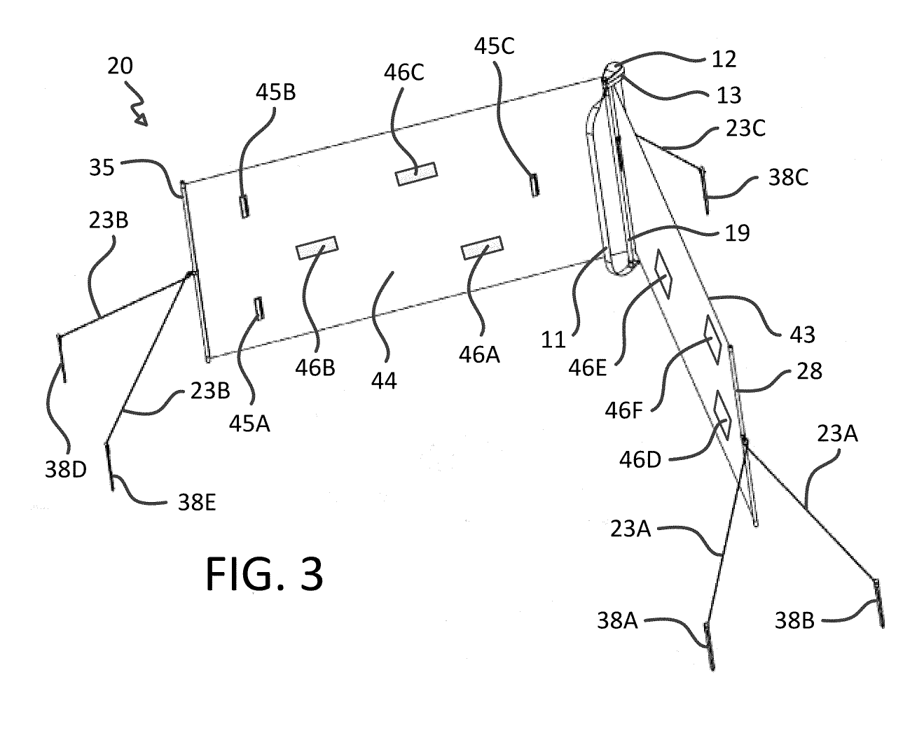

Stakes inserted into the ground and tied with ropes to the blind assembly are used for setting up the blind assembly 10 in a field to be used as camouflage for a hunter. FIG. 3 shows the set up assembly in a ready to use configuration 20. Stakes 38A and 38B are attached to handle rod 28 using tie back rope 23A, stakes 38D and 38E are attached to handle rod 35 using tie back rope 23B, and stake 38C is attached to reel tube 41 through tie back rope 23C. In an assembled state, the ropes 23A, 23B and 23C are coiled up and stowed along with stakes 38A-38E in pockets 45A, 45B and 45C disposed on sheet 44. Pockets 45A and 45B are located near handle rod 35 and contain the stakes and ropes used for tying the handle rods while pocket 45C is located in the vicinity of the real tube 41 and stows the rope and stake for the reel tube 41.

Securing the tie back ropes 23A and 23B to the handle rods 28 and 35 is done through grommet holes disposed in the fabric loops 15 and 31 behind handle rods 35 and 28 respectively. Securing the tie back rope 23C is done through an opening in reel tube 41 using washers 33A and 33B fastened to the sides of the opening and knots tied on either side of the washers to keep the rope end from pulling through the reel tube opening. In an alternative embodiment, the rope having a knot at the attaching end is wedged into a key slot opening disposed at the bottom of the middle housing 13.

The sheets 43 and 44 may have camouflage designs printed on their surfaces to help conceal the hunter. The sheets 43 and 44 may also contain look out flaps shown by 46A, 46B and 46C in FIG. 3 for the hunter to peek through.

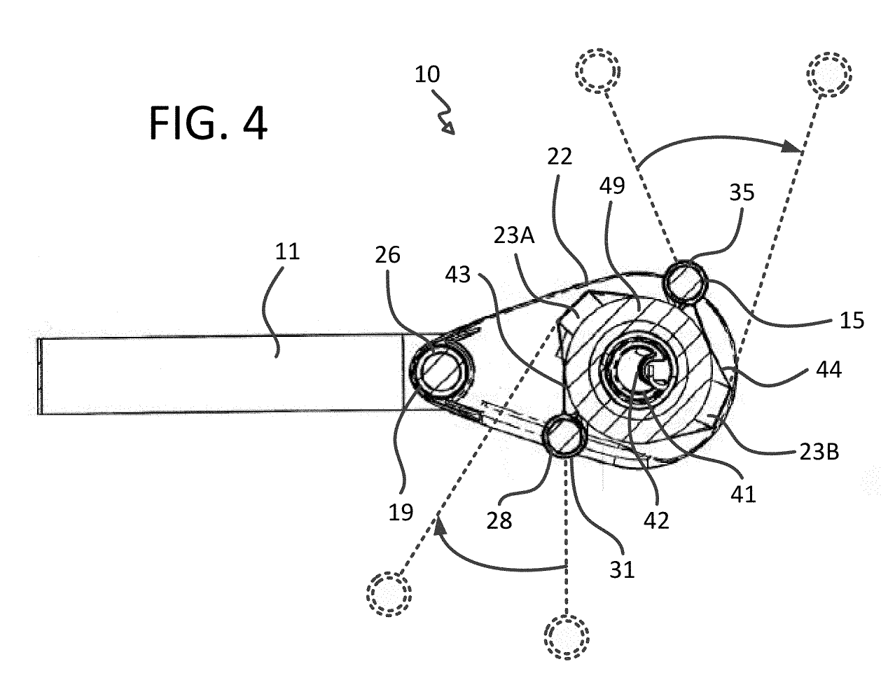

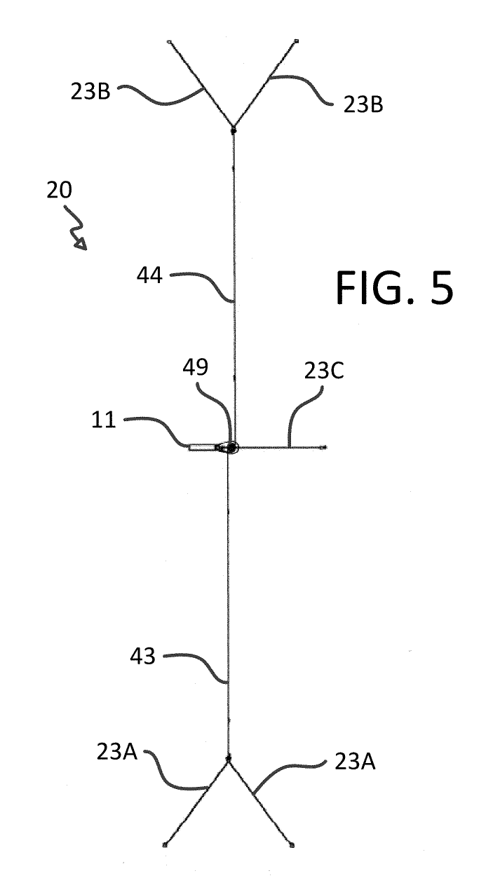

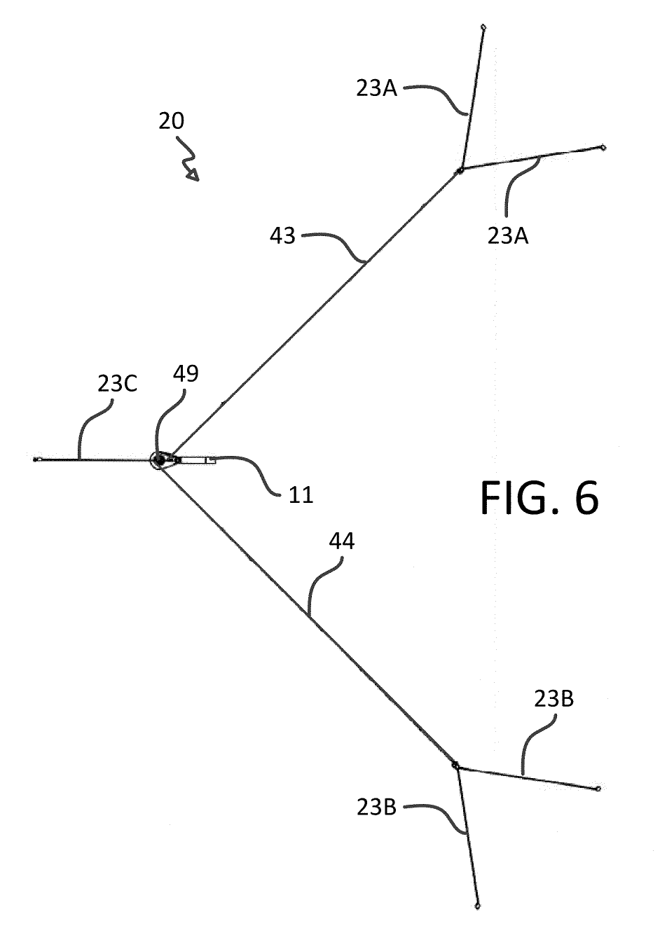

In a typical setup, the angle between the outstretched sheets 43 and 44 is 90 degrees as shown in FIGS. 3 and 6. The angle between the sheets may be changed at the discretion of the hunter to between 0.0 and 180 degrees. Angle adjustment may be accomplished as shown in FIG. 4. FIG. 5 shows a 180 degree angle setup. In practical terms, the hunter would set the angle that gives him/her the best camouflage given the topography of the area.

To set up the blind assembly, one of the handle rods would be attached to stakes inserted into the ground as the first step. The strap end would then be pulled out which would outstretch the anchored sheet while the other handle rod and sheet would temporarily flop down. Next, the reel tube end would be attached by rope 23C to stake 38C and finally the other handle rod would be attached by rope to its corresponding stakes.

It should be understood, of course, that the foregoing relates to exemplary embodiments of the invention and that modifications may be made without departing from the spirit and scope of the invention.

I claim:

1. A retractable blind assembly comprising:
a reel tube having a top end and a bottom end;
a first sheet and a second sheet, said first sheet joining the second sheet to form a combined sheet having a rear end and a front end, said combined sheet being wound over the reel tube to form a sheet roll with the rear end of the combined sheet being disposed inside the roll to form a retracted configuration, said first sheet and second sheet being configured for unwinding from the sheet roll separately to form an outstretched blind at an angle, said first sheet having a front end and said second sheet having a front end;
a base housing adapted for placement onto a ground surface, said base housing containing a rear vertical extension and a front vertical extension, said bottom of the reel tube being adapted to fit onto the front vertical extension of the base frame;
a tie rod having a top side and a bottom side, said bottom side being adapted for placement into the rear vertical extension of the base housing;
a torsion spring adapted to tightly fit inside the reel tube, said torsion spring being adapted for applying tension onto the outstretched blind; and
a housing assembly attached to the top of the sheet roll and the top of the tie rod.

2. The retractable blind assembly of claim 1 further comprising a first handle rod being attached to the front end of the first sheet and a second handle rod being attached to the front end of the second sheet.

3. The retractable blind assembly of claim 2 wherein attaching the first handle rod and the second handle rod is accomplished by inserting said handle rods into looped pockets sewn to the front ends of the respective sheets.

4. The retractable blind assembly of claim 2 further comprising a sleeve adapted to slide over the tie rod to reinforce the tie rod.

5. The retractable blind assembly of claim 4, further comprising a strap attached at one end to a top of the tie rod sleeve and at another end to a bottom of the base housing.

6. The retractable blind assembly of claim 1 wherein the housing assembly comprises a middle housing member attached at one end to the top of the tie rod, said housing assembly also comprising an upper housing member for covering the middle housing.

7. The housing assembly of claim 1 further comprising a plurality of tie back ropes and a plurality of stakes used for setting up the retractable blind assembly, said stakes and ropes being stowed inside pockets disposed on a surface of the first or second sheet.

8. The housing assembly of claim 1 further comprising a plurality of look out flaps in the first and second sheets for the hunter to peek through.

9. The housing assembly of claim 2 further comprising stops attached to a top side and to a bottom side of the first handle rod and the second handle rod to prevent excessive rewinding of the sheets.

10. The housing assembly of claim 2 further comprising a first clamp fastened onto the looped pocket containing the first handle rod and a second clamp fastened to the second handle rod to prevent the handle rods from sliding out of their respective looped pockets.

11. The housing assembly of claim 10, further comprising a grommet hole disposed in the looped pocket containing the first handle rod and a grommet hole disposed in the looped pocket containing the second handle rod for attaching tie back ropes.

12. The housing assembly of claim 1 further comprising a hole in a center portion of the reel tube for sliding through a tie back rope used for attaching the assembly in the course of assembly setup.

13. The housing assembly of claim 1 further comprising a slot disposed at a bottom of the middle housing for wedging a knot of a tie back rope used for attaching the assembly in the course of assembly setup.

14. The housing assembly of claim 1 further comprising camouflaged designs printed onto an outer side of the first and second sheets.

15. The housing assembly of claim 14 further comprising camouflaged designs printed onto an inner side of the first and second sheets.

16. The housing assembly of claim 1 wherein the angle of the outstretched blind may vary from about 90 to about 180 degrees.
